(19) United States
(12) Patent Application Publication
(10) Pub. No.: US 2005/0256747 A1
(43) Pub. Date: Nov. 17, 2005

(54) System and method for underwriting payment processing risk

(76) Inventor: Robert Michael Hellrigel, Ridgefield, CT (US)

Correspondence Address: Robert Hellrigel;Capital Path, Inc., Suite 303, 8 Knight Street, Norwalk, CT, 06851, US

(21) Appl. No.: 10/834,768

(22) Filed: Apr. 28, 2004

(51) Int. Cl. G06F 17/60

(52) U.S. Cl. 705/4

(57) ABSTRACT

A method, using a computer system, for underwriting the risk of non-payment associated with processing non-cash payments on behalf of a merchant by managing balances in pledged collateral accounts owned by one or a plurality of underwriters. The invention determines the initial amount of required collateral, in total and for each participating underwriter, as a function of estimated sales and recalculates required collateral, as payment transactions and other transactions affecting collateral accounts occur. In the event of an anticipated underwriter collateral shortfall, the underwriter is notified that a collateral increase is required. Payment processing is suspended if collateral shortfall is imminent.

### CROSS-REFERENCE TO RELATED APPLICATIONS

Not Applicable

### FEDERALLY SPONSORED RESEARCH

Not Applicable

### BACKGROUND OF THE INVENTION

1. Field of the Invention

This invention relates generally to the field of financial transactions, and in particular to the management of risk associated with the processing of non-cash payments. More specifically, the invention relates to the insuring of payment processing entities against potential losses incurred as a result of payments that fail to clear.

2. Discussion of Related Art

Non-cash payment transactions, such as checks, credit cards, debit cards, or electronic fund transfers, play an important part in today's economy. Essentially, any type of person, entity, organization, business, or the like may have the need to take non-cash payments for goods and services, and, for convenience of discussion, are generally referred to herein as “merchants”. Such a transaction proceeds by submitting the payer's account information along with the requested payment amount to a processing system. Such a processing system may involve the merchant's bank, a credit card association, the issuer's bank as is known in the art, and the payer's bank.

Hence, in order to process non-cash payment transactions, the merchant must typically establish an account with a processing organization, usually a bank, referred to herein as “processor”. Such payments carry a risk of non-payment. Non-payment may be caused for many reasons including insufficient funds, invalid account information, fraud or repudiation of charges. Because it may indicate fraud, processors are particularly sensitive to non-payment because the payer claims the payment was not authorized. Non-payment may be detected immediately, or may occur weeks or months after the transaction was initiated.

In order that the merchant has access to funds as soon as possible, the processor may credit the merchant's account before the payment is actually collected, or before the payer's statutory time limit to repudiate the transaction has expired. If a transaction does fail for non-payment and the merchant has already been credited, the processor must then debit the merchant's account to recover the funds.

This practice relies on funds being available in the merchant's account to execute the debit, thereby exposing the processor to a financial risk. Because of this risk, the merchant typically undergoes an application and underwriting process before the account is opened. Factors such as the merchant's credit report, industry, method of sales and time in business are considered.

If the merchant cannot meet the processor's minimum underwriting requirements he may be denied a merchant account. Such a high-risk merchant, who is unable to obtain a regular merchant account, may apply to a payment services reseller.

A reseller acts as an intermediary between the merchant and a processor. The reseller has a merchant account with the processor. The merchant sends the payments to the reseller who, in turn, sends the payments to the processor. In effect, the reseller uses its funds and credit to guarantee that funds will be available to the processor, should it be necessary to retrieve funds because of non-payment.

In this way the reseller provides the high-risk merchant with payment services, but typically at higher rates and less favorable terms than a processor. Resellers often retain a portion of the merchant's sales for a long period of time as insurance against non-payment transactions.

Using a reseller may be a merchant's only alternative to obtain payment processing services. However, this method suffers from a number of disadvantages.

There are disadvantages for the merchant.
(a) The merchant pays higher transaction fees. The merchant is covering the fees of both the reseller and those of the underlying processor.
(b) The merchant's access to his sales revenue is delayed due to a longer period between submitting the transaction to the reseller and receiving the funds, and the portion of the payment that is retained by the reseller as a reserve for an even longer period of time.
(c) The merchant has a potentially large portion of his sales revenue held by an unregulated reseller rather than a regulated and insured processor.
(d) Should the merchant's risk status improve enough to qualify for payment services elsewhere at more advantageous rates, significant costs may be incurred switching processing procedures, point-of-sale equipment or computer systems.
(e) The payment charge usually appears on the payer's checking or credit card account in the reseller's name, not the merchant's. This may cause confusion for the payer and make it more difficult for the merchant to administer a strong refund policy; thereby preventing some non-payments because the payer has claimed the payment was not authorized.
(f) The merchant has access only to the payment processing technology and methods the reseller provides. Many resellers are small businesses and offer limited options.
(g) Reseller's often manage the amount of risk they assume by imposing limits on the amount of payments they will accept for a given period of time. The merchant may lose his ability to processes payments once a limit has been reached.

There are disadvantages for the reseller.
(a) Although the true service they provide to the merchant is credit insurance, they must provide technology and administration to process payments, sometimes duplicating the work of the processor who must also handle the payment. This creates unnecessary overhead that is passed on to the merchant in the fees charged.
(b) One merchant's activity may jeopardize the reseller's entire business. From the processor's perspective the reseller is a single merchant. Excessive non-payments due to unauthorized transactions, or fraudulent behavior of one merchant, jeopardizes the reseller's credit and relationship with the processor. In some cases, this may result in the reseller losing its merchant account with the processor, possibly putting the reseller out of business.
(c) The reseller is responsible to the processor for 100% of the payments it accepts on behalf of the merchant. It cannot easily share the risk with another reseller. Conversely it cannot easily accept a share of risk in a merchant that is a client of another reseller.

There are disadvantages for the processor.
(a) The processor must turn away business if the merchant cannot meet its minimum underwriting requirements.
(b) The processor must rely on only their own sales resources for attracting acceptable merchants. Their universe of potential merchants is limited to those that can meet their acceptable risk level.
(c) If the processor accepts reseller accounts it is insulated from the merchant, who is truly the originator of the payment transactions. This creates a potential breech of compliance with regulations imposed by authorities, such as the National Automated Clearing House Association (NACHA), the state banking department, or US Treasury Department, which increasingly demand that firms dealing with financial transactions know their customers.
(d) The processor must provide competitive payment processing technology and sufficient administrative support to attract and retain merchants. A greater number of merchants serviced and transactions processed allows for better economies of scale. However, the more restrictive the processor's minimum underwriting requirements, the fewer the merchants it will find suitable to service.

The above has been a discussion of the payment processing industry's current state of the art as it pertains to payment processing for high-risk merchants. However, the invention is, in some sense, a new form of credit insurance and some existing forms of credit insurance and their embodiments deserve discussion.

Credit insurance is insurance against loss resulting from failure of debtors to pay their obligations to the insured. It guarantees to manufacturers, wholesalers and service organizations payment for goods shipped or services rendered.

Accounts receivables insurance, allows a business to purchase a policy, which protects it against customer nonpayment. Generally, it provides coverage against all forms of debtor insolvencies and against nonpayment of all past-due accounts filed with the insurer within 90 days after their original due date. There are two basic forms: general coverage policies that insure all of an insured's accounts receivable, and specific coverage for accounts receivable submitted to the insurer by name. The insurer evaluates the credit of the customer and sets the premium based on the customer's credit rating and the limits of coverage.

Mortgage insurance is a common form of credit insurance. Mortgage insurance protects a lender against borrower default. Lenders recognize a strong correlation between borrower equity and default. If a borrower desires to contribute less than what the lender would consider a sufficient portion of the purchase price the lender may require mortgage insurance. The insurer evaluates the borrower's credit and issues a policy naming the lender as beneficiary. Policy premiums are based on borrower's credit rating and size of the loan amount insured. The borrower is responsible for paying the premiums.

Lease insurance, another form of credit insurance, protects a lessor against lessee default, covering a lessor against nonpayment of rental installments by the lessee in a capital equipment or real estate lease transaction. The insurer evaluates the credit of the lessee and sets the premium based on the lessee's credit rating and the amount of the lease obligation.

Credit health insurance, another form of credit insurance, is disability or health insurance sold by a lender to cover payment of a debt or an installment loan, in the event the debtor is disabled.

Collateral assignment, an embodiment of credit insurance, is the transfer of benefits or payments under a life or property insurance policy to a creditor as part of the security for a loan. The creditor has a right only to the portion of the policy's proceeds equal to the creditor's remaining interest or value in the loan.

### BRIEF SUMMARY OF THE INVENTION

The invention provides methods for an entity to underwrite the risk of processing merchant payments, so that the processor may be exposed only to that level of risk dictated by their own risk management standards.

In effect the invention provides a system and method to insure merchant credit allowing processors to deal with high-risk merchants, for all intents and purposes, as low-risk merchants.

This is achieved by determining on a merchant-by-merchant basis the maximum amount of collateral as a function of sales that must be pledged to the use of the processor to insure to its satisfaction that there will, at all times, be a sufficiency of funds to cover anticipated non-payments.

It is further achieved by the process of a person, entity or business, herein referred to as “underwriter”, pledging and providing the amount of required collateral. The collateral may also be pledged and provided by a plurality of underwriters, using various methods for apportionment.

It is still further achieved by the ongoing process of applying all relevant financial transactions to both merchant and underwriter collateral accounts and performing calculations to determine and insure the continued sufficiency of funds to cover non-payments.

In the event of an anticipated collateral shortfall the underwriter is notified to make a deposit or take other corrective action. In the event of an imminent collateral shortfall payment processing may be suspended.

The methods may conveniently be implemented over a computer network, such as the Internet, and may use hardware and software that are configured to operate in a network environment. For example, the invention may employ one or more server computers that access one or more data devices, such as databases, to store and process the information. Essentially any type of computer that may communicate over a network may be used to access and display this information as is known in the art.

### OBJECTS AND ADVANTAGES

The invention creates more direct and productive relationships among merchants, providers and resellers. It eliminates redundant labor and capital-intensive processes creating advantages for all parties.

Please note, because the invention allows the reseller to concentrate on insuring the merchant's credit risk and avoid handling payment transactions entirely, they will be subsequently referred to as “underwriter” in references to the invention.

There are advantages for the merchant.
(a) Because the costs of building and maintaining technology are eliminated the savings can potentially flow to lower transaction costs for the merchant. Once using the centralized technology and administration, underwriters may be substituted based on comparative pricing or even eliminated if the merchant's risk factors improve, potentially cutting costs dramatically.
(b) The merchant has more control over the amount of access he has to his sales revenue. He may request that more or less of his revenue be collateralized by underwriters. Although the merchant would be paying more in fees for earlier access to funds, this is flexibility not easily available using a reseller in the current state of the art.
(c) The merchant has an account and maintains his funds with the processor rather than the reseller. Processors are typically regulated and insured banks. Resellers are typically unregulated private businesses.
(d) Should the merchant's risk status improve, there is no need to switch from a reseller to a provider. Therefore, the merchant can avoid the cost and confusion of switching technology such as point-of-sale equipment or computer systems, or changing administrative procedures.
(e) The payment charge appears on a payer's checking or credit card statement in the merchant's name, not the reseller's. This may eliminate confusion for the payer and make it easier for the merchant to administer a strong refund policy, thereby preventing some non-payments because the payer does not recognize the charge and has claimed the payment was not authorized.
(f) The invention is by its nature and intention to be used by multiple risk underwriters. This pooling creates a greater economy of scale permitting more resources to be devoted to technology and customer services that can be accomplished by resellers working independently.
(g) The merchant is not bound by preset limits. If sales are unexpectedly high and original pledged collateral limits are exceeded the excess may be held as collateral in the merchant's account, the current underwriters may agree to expand coverage, or new additional underwriters may be used to insure the overage. It should never become necessary to stop processing payments.

There are advantages for the underwriter (formerly the reseller).
(a) The need to provide technology and administration to process payments is eliminated. The underwriter does not handle transactions at all. The underwriter need only concentrate on evaluating merchant risk in order to determine transaction fees, and providing the capital and credit as collateral to insure the payments. Unnecessary overhead is eliminated.
(b) Merchant accounts are held individually by the processor in the merchant's name, not pooled together within the reseller's account. If the merchant has excessive non-payments due to unauthorized transactions, or commits fraud, this may result in losses for the underwriter, however, it does not jeopardize other merchant accounts. The damage to the underwriter is contained and limited to the collateral pledged to that merchant.
(c) The underwriter is not required to pledge collateral for 100% of a merchant's payments. The invention makes it easy for multiple underwriters to participate in the payments of a single merchant. Thereby allowing them to spread their risk over a greater number of merchants.

There are advantages for the processor.
(a) The processor no longer has to turn away high-risk merchant business. It can use underwriters to apply the collateral needed to keep the risk acceptable.
(b) The processor no longer must rely on only their own sales resources for attracting acceptable merchants. Resellers turned underwriters, will be motivated to introduce merchants previously unacceptable to the processor. The universe of potential merchants is no longer limited to those that can meet the processor's acceptable risk level based solely on their own credit.
(c) The processor holds the merchant's account and therefore has a direct relationship. This permits the processor to know more about the true originator of the payment transactions. The processor is now in a stronger position to comply with regulations imposed by authorities, such as the National Automated Clearing House Association (NACHA), state banking department, or US Treasury Department.
(d) The processor now services a wider universe of potential merchants. This allows for better economies of scale to provide competitive payment processing technology and sufficient administrative support.

Although the invention may also be broadly classified as credit insurance it addresses an entirely different type of financial transaction, and presents an entirely new method of loss protection. The invention does not deal with promised future payments, nor does the invention require a credit evaluation of the payer, as do the forms of credit insurance described above or currently known in the art.

### DRAWINGS—FIGURES

In the drawings, closely related figures have the same number but different alphabetic suffixes.

FIG. 1 is a schematic overview of the invention.

FIG. 2 is a relational database schema showing details of data employed.

FIG. 3 is a description of the workflow products that are referenced in FIGS. 4, 5, 6 and 7.

FIG. 4 is an illustration of workflow to determine required collateral and underwriter apportionment.

FIG. 5 is a flowchart further detailing the collateral manager processing as it pertains to its operation in FIG. 4.

FIG. 6 is an illustration of workflow describing an ongoing process of applying account actions and payment actions to determine collateral sufficiency.

FIG. 7 is a flowchart further detailing the collateral manager processing as it pertains to its operation in FIG. 6.

### DRAWINGS—LIST OF REFERENCE NUMERALS

001 Processor Computer
002 Merchant Computer
003 Collateral Manager Computer
004 Gateway Computer
005 Underwriter Computer
006 Network/Internet
007 Collateral Manager
008 Merchant
009 Processor
010 Gateway
011 Underwriter
012 Sales Estimate
013 Application
014 Preliminary Contract A
015 Preliminary Contract B
016 Preliminary Contract C
017 Apportionment
018 Contract
019 Payment
020 Account Action
218 Day Types Table
219 Estimated Sales Table
220 Est. Sales×Pay Method Table
221 Est. Sales×Pay Type Table
222 Est. Sales×Order Method Table
223 Contracts×Fees×Underwriters Table
224 Actual Estimate Ratio Ranges Table
225 Elapsed Time Ratio Ranges Table
226 Sales Reductions Table
227 Contracts×Sales Reductions
228 Funding Notices Table
229 Halt Payments Table
501 Receive Transmission
502 Application and Sales Estimate?
503 Store Sales estimate and application
504 Calculate collateral requirement, construct preliminary contract A
505 Transmit preliminary contract A to processor
506 Preliminary contract B?
507 Update contract to preliminary
contract B
021 Non-Payment Notice
022 Collateral Requirement
023 Funding Notice
024 Halt Payments Notice
025 Sales Reduction Rules
200 Database
201 Accounts Table
202 Contracts Table
203 Contracts×Fees Table
204 Contracts×Underwriters Table
205 Processors Table
206 Transactions Table
207 Underwriters Table
208 Payment Methods Table
209 Fees Table
210 Merchants Table
211 Order Methods Table
212 Payment Types
213 Repudiation Limits Table
508 Transmit preliminary contract B, application and sales estimate to underwriters
509 Apportionment?
510 Store apportionment, construct preliminary contract C
511 Transmit preliminary contract C to merchant
512 Contract?
513 Unrecognized transmission
514 Update contract
515 Enable daily processing
701 Post account action and determine new account balance
702 Post payments and non-payment notices
703 calculate revised estimated sales
704 calculate collateral requirement and transmit to processor
705 Is underwriter collateral sufficient for estimated sales?
706 Is underwriter collateral sufficient for actual sales?
707 Does underwriter have overdue funding notices?
708 Transmit funding notice to underwriter
709 Transmit halt payments notice to gateway
710 Replace Underwriter or take other remedial action
214 Journal Entries Table
215 Journal Entry Types Table
216 Non-Payments Table
217 Non-Payment Types Table

### DETAILED DESCRIPTION—PREFERRED EMBODIMENT

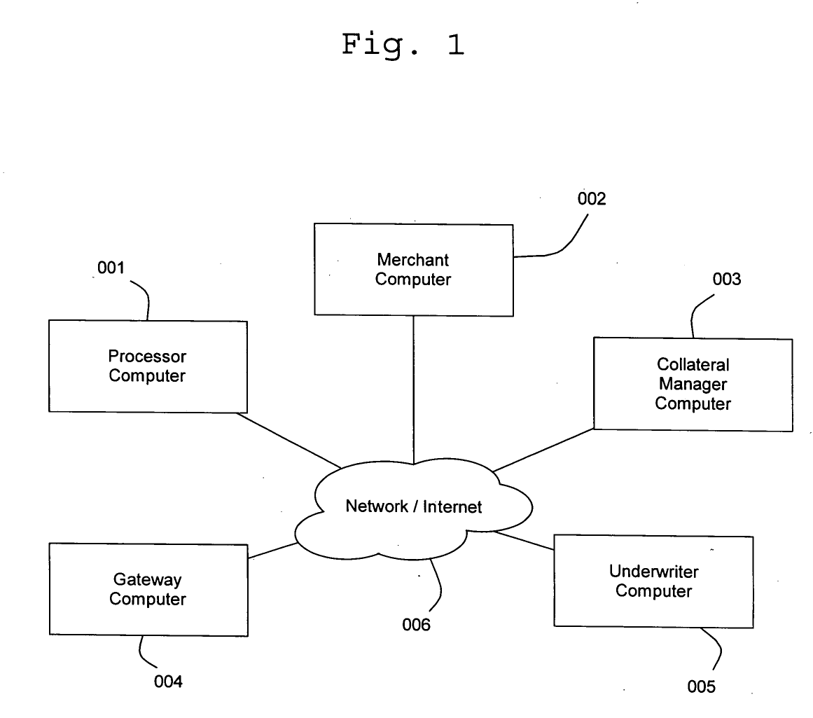

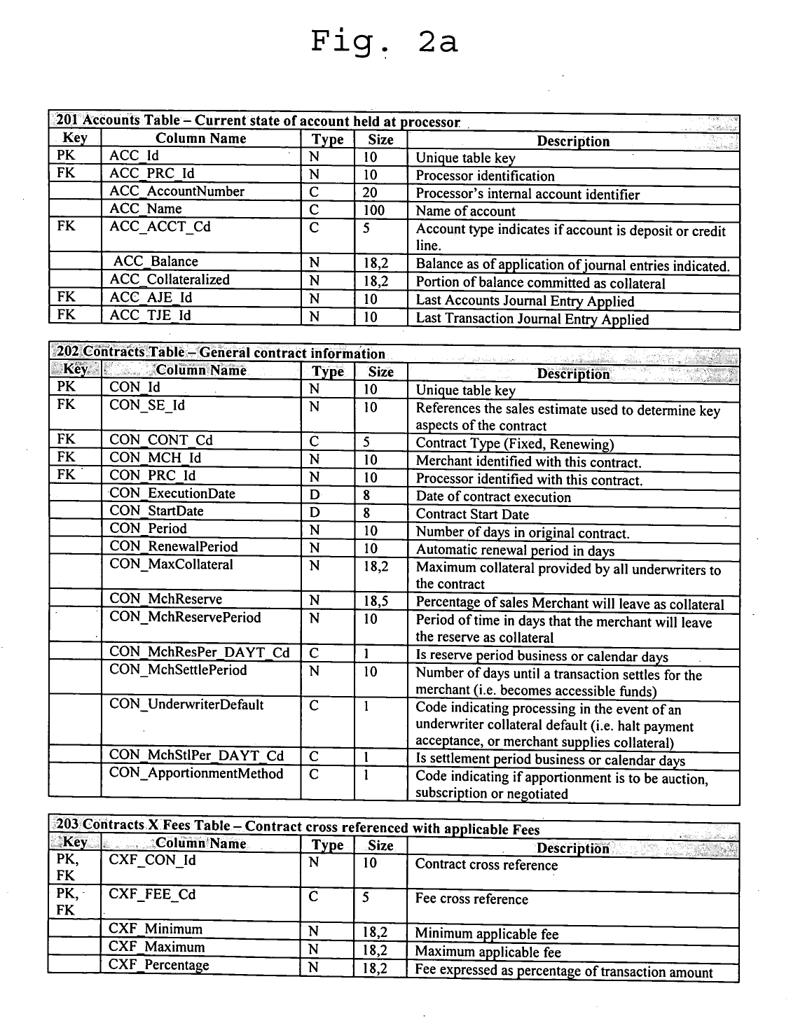

Referring now to FIG. 1 one embodiment of the system will be described. In doing so it will be appreciated that other arrangements may be used and it is not intended to be limited to only the system shown in FIG. 1.

The system transmits data using a network 006, such as the Internet. The configuration may employ some computers as server computers supplying web pages and services for entry and receipt by other computers acting as client computers.

The merchant computer 002 supplies the information necessary to evaluate his business and the quantitative sales information. Quantitative information is evaluated by the collateral management computer 003. The results including collateral requirements are made available to the processor computer 001 along with the other merchant information supplied.

The results of the payment processor's evaluation along with collateral requirements are made available to the underwriter computer 005.

The result of the underwriter's evaluation is a decision whether or not to participate in insuring the merchant's payments, and if so to what limit and what fee structure. Results are made available to the applying merchant's computer 002 for approval before initiating day-to-day processing.

When day-to-day processing is initiated, the merchant computer 002 transmits payment transactions to the gateway computer 004. The gateway computer 004 is a system designed to collect and route payment transactions. Such a gateway is well known in the art and the detailed operation of which is not necessary to specify. However, communication with such a gateway is necessary to the operation of the invention.

The gateway computer 004 routes or makes available the merchant's payment transactions to both the processor computer 001, for clearing and settlement, and the collateral manager computer 003, for monitoring of collateral balances.

The processor computer 001 clears and settles the payment transactions through the banking system. Results of clearing and settlement as well as activity to merchant and underwriter accounts held or controlled by the processor are transmitted to the collateral manager computer 003.

The collateral manager computer 003 transmits updated collateral requirements to the processor computer 001 so that funds in collateral accounts can be properly restricted to prevent over withdrawal, and thereby a collateral deficiency.

The collateral manager computer 003 may notify the underwriter computer 005 and the gateway computer 004 if collateral balances fall below threshold levels.

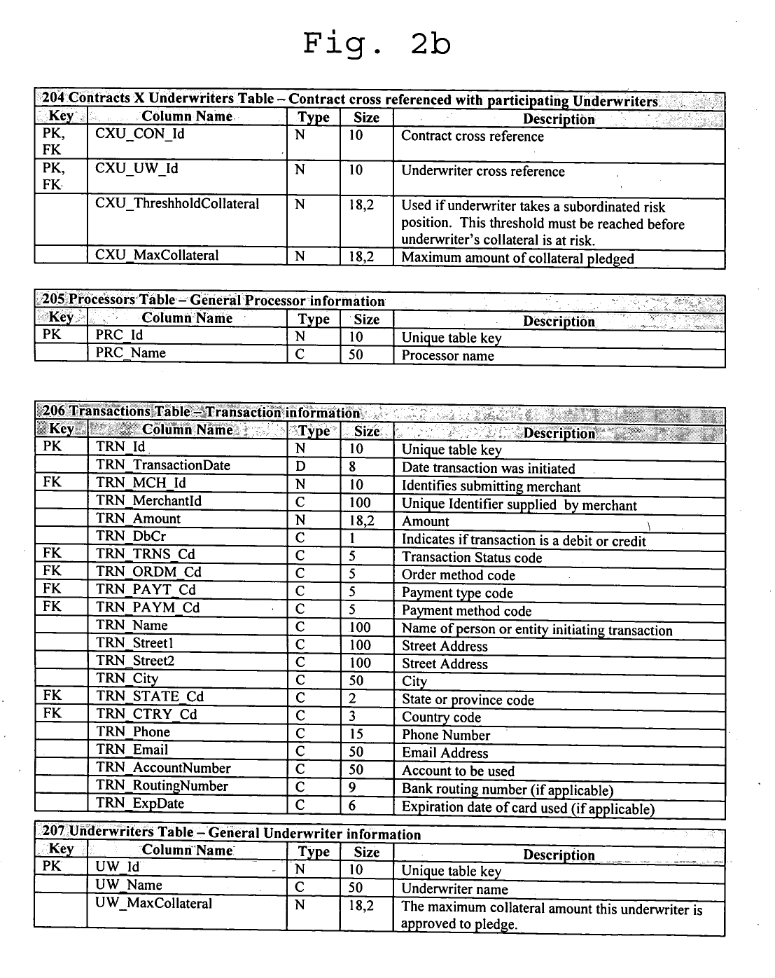

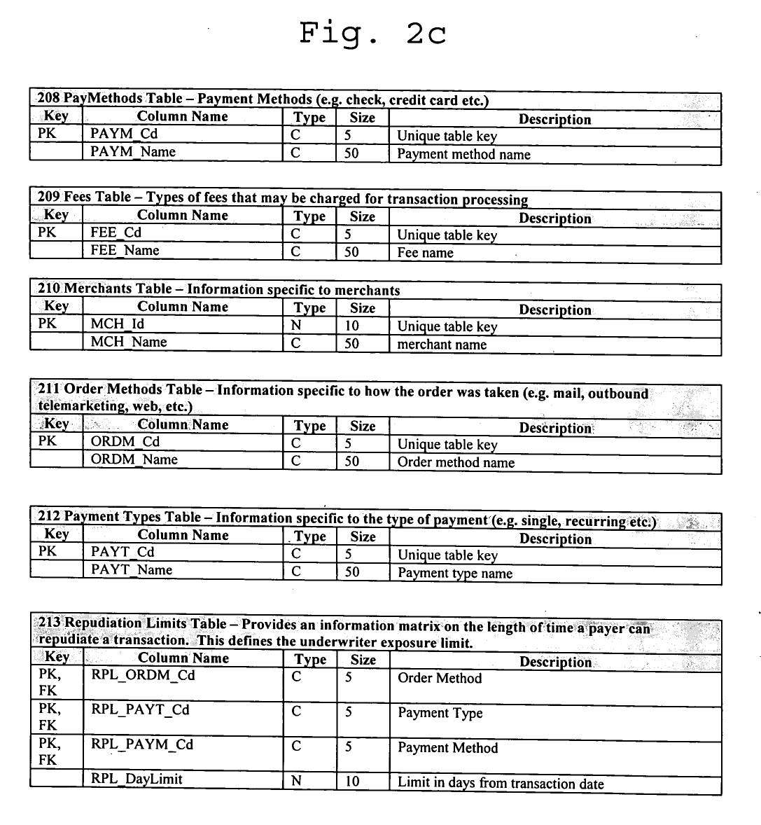

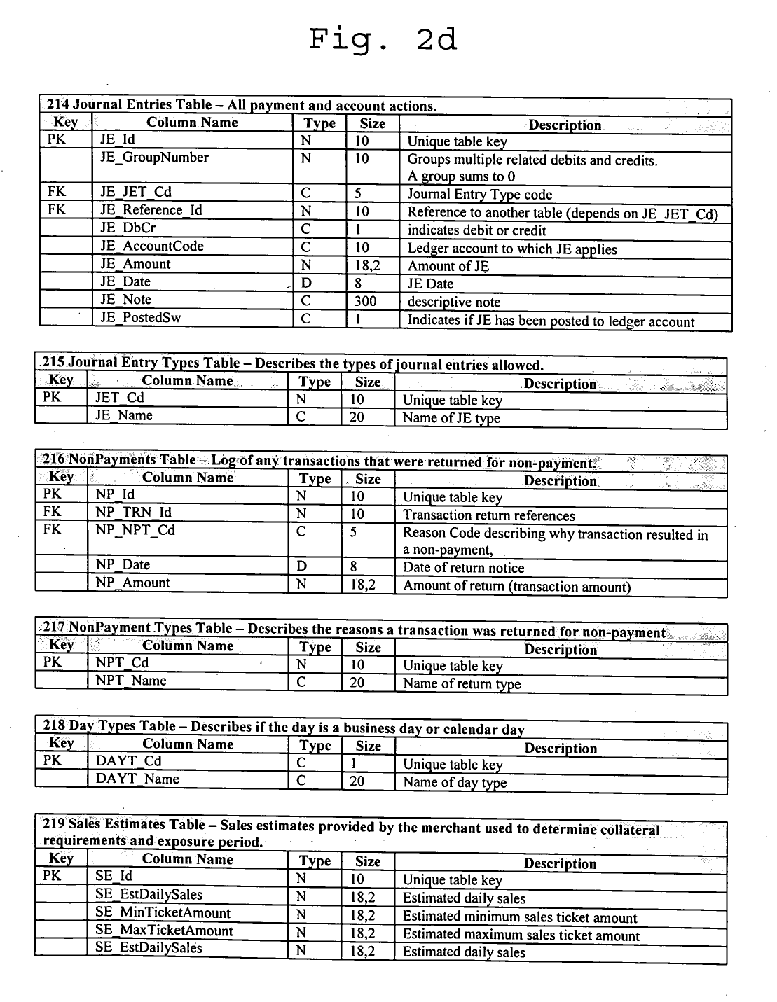

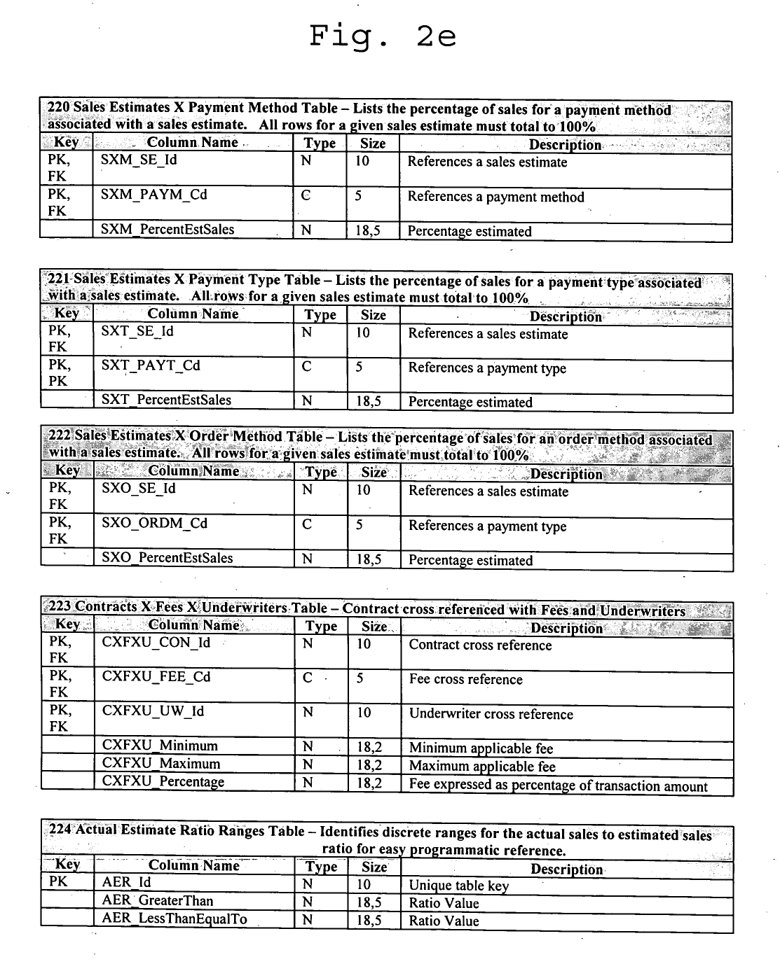

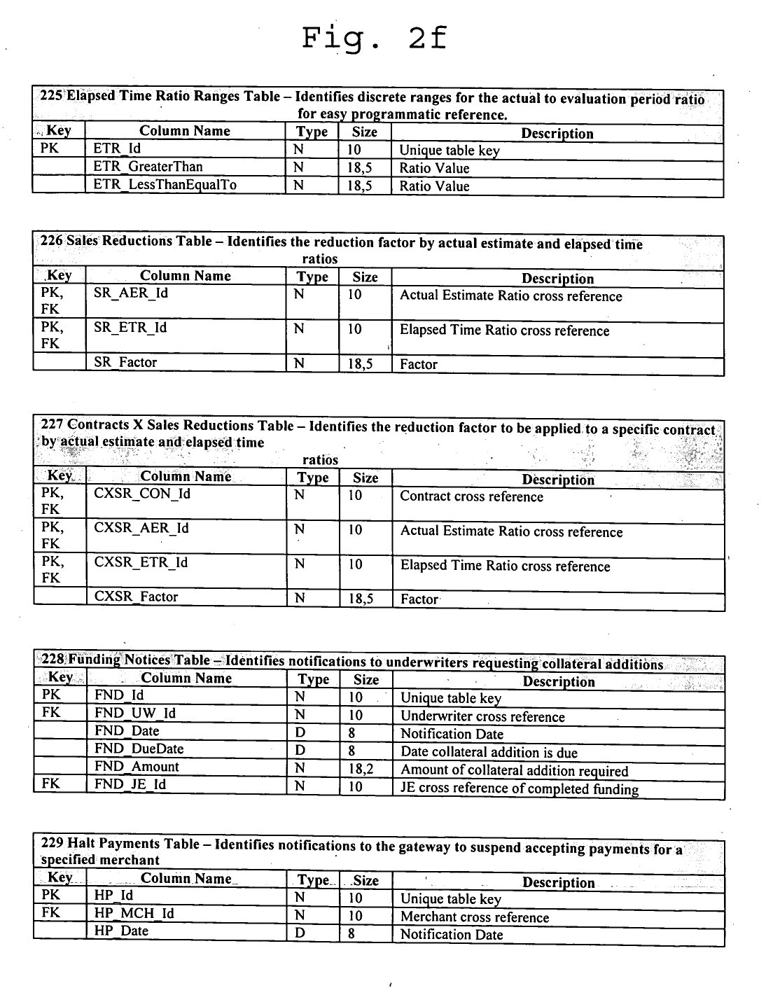

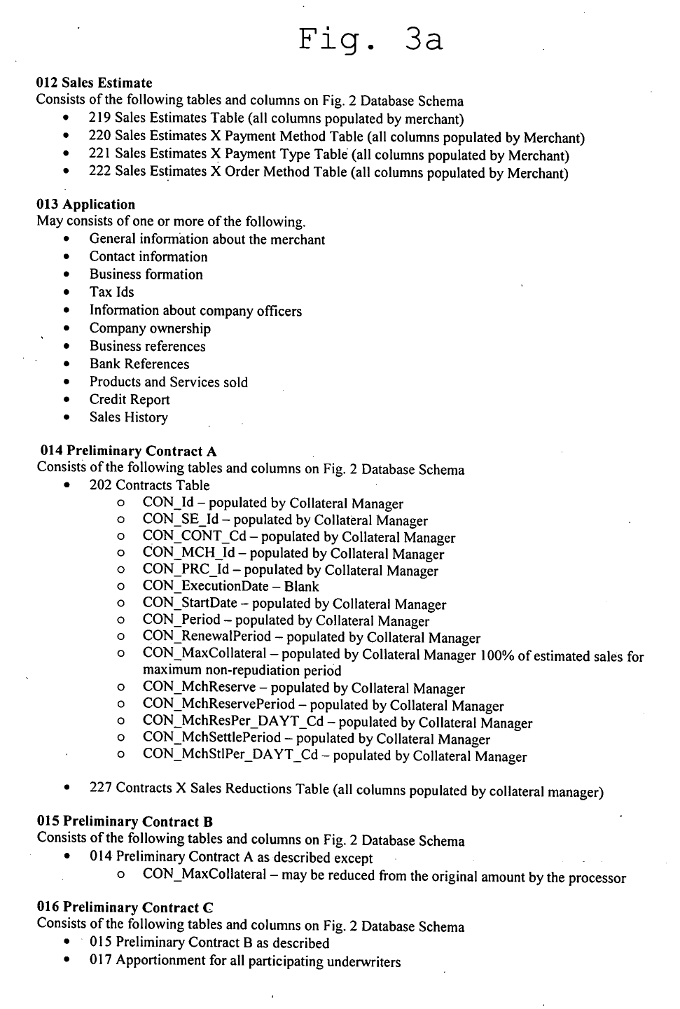

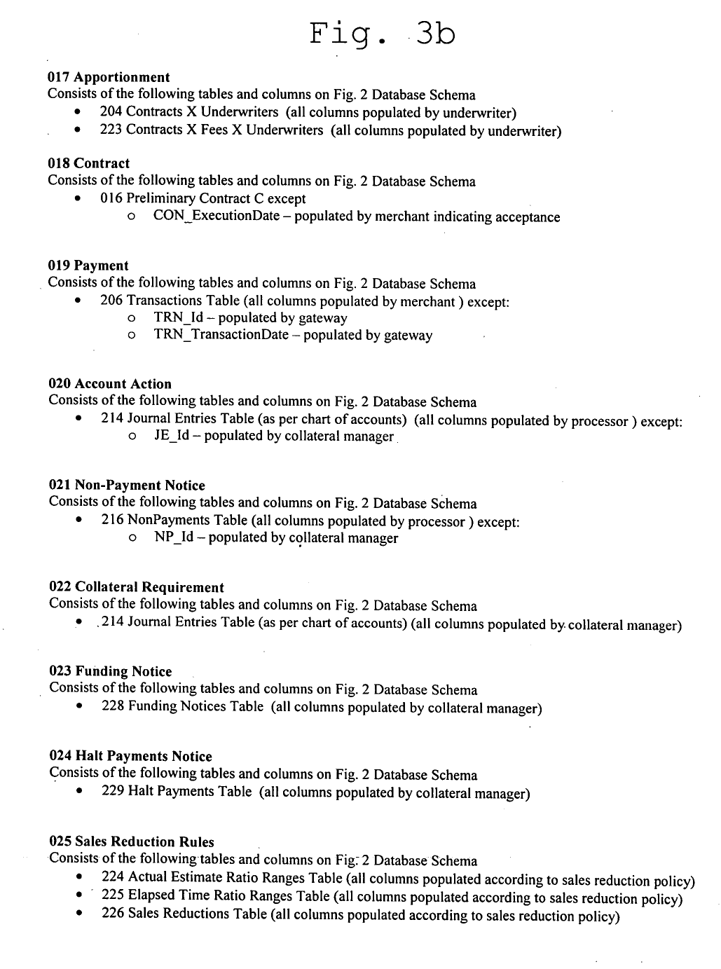

FIG. 2 describes a database schema that provides detail of the data employed by the invention. Data elements are individually described as columns and grouped logically into tables.

Invention workflow products may be a combination of one or more columns spanning one or more tables. FIG. 3 provides the details of such workflow products in most cases in terms of the data elements fully described in FIG. 2. The exception to this is the application 013, which is described only generally because specific contents of the application are not important to the invention. Reference to the application 013 is included for clarity of description.

FIG. 4 illustrates the workflow to determine collateral requirements and underwriter apportionment. The end result is a contract 018 which specifies all relevant terms and binds all parties.

The merchant 008 submits sales estimate 012 and application 013 to the collateral manager 007. The application 013 contains information that is used by the processor 009 and the underwriter 011, which may be a plurality of underwriters, to access risk subjectively by their own internal standards and procedures. The contents of the application 013 and the internal risk evaluation procedures of the processor 009 and the underwriter 011 are not part of the invention. The application 013 is included only to help clarify the workflow.

The collateral manager 007 stores the sales estimate 012 in the database 200. Preliminary contract A 014 is constructed using the sales estimate 012 and repudiation limits table 213 by conservatively assuming that the estimated sales will incur a 100% non-payment rate over the longest repudiation limit applicable. The collateral manager also incorporates the current sales reduction rules 025 into the preliminary contract A 014, which describe the terms that affect collateral calculations should actual sales fall significantly below estimated sales. The sales estimate 012, application 013, and preliminary contract A are transmitted to the processor 009.

The processor 009 reviews the sales estimate 012, application 013, and preliminary contract A 014. Using its own internal procedures the processor 009 determines if the merchant's sales must be collateralized at the conservative 100% rate calculated or if the processor 009 will assume some risk. If the processor 009 is willing to assume some risk the maximum collateral required in the preliminary contract A 014 is reduced. The preliminary contract A 014 now becomes preliminary contract B 015 and is transmitted back to collateral manager 007. The collateral manager 007 stores the preliminary contract B 015 on the database 200 and transmits the sales estimate 012, application 013, and preliminary contract B 015 to the underwriter 011.

The underwriter 011 evaluates the information using their internal procedures in order to arrive at an apportionment 017, which is the amount of collateral that the underwriter will commit, the fees that will be charged for the coverage, and the risk position that the underwriter's collateral will take relative to the collateral pledged by other participating underwriters. This is transmitted to the collateral manager 007.

The final apportionments may be arrived at by several methods including auction, subscription or private negotiation.

If final apportionments are to be determined by auction the underwriter's submitted apportionment is treated as a bid and compared with other underwriter apportionments to determine the most advantageous combination for the merchant.

If final apportionments are to be determined by subscription the merchant sets the fees and risk positions and invites underwriters to subscribe. The underwriter's submitted apportionment may only vary the amount of the collateral he will contribute.

Apportionments may also be privately negotiated previous to submission, whereby the apportionment that the underwriter submits is expected and accepted as is.

The collateral manager stores the apportionment 017 incorporates an aggregate of the fees portion of the apportionment 017 into preliminary contract B 015 forming preliminary contract C 016. Preliminary contract C 016 is then transmitted to the merchant 008.

The merchant 008 reviews and accepts the preliminary contract C 016, resulting in a contract 018 binding all parties and forming the basis for day-to-day processing.

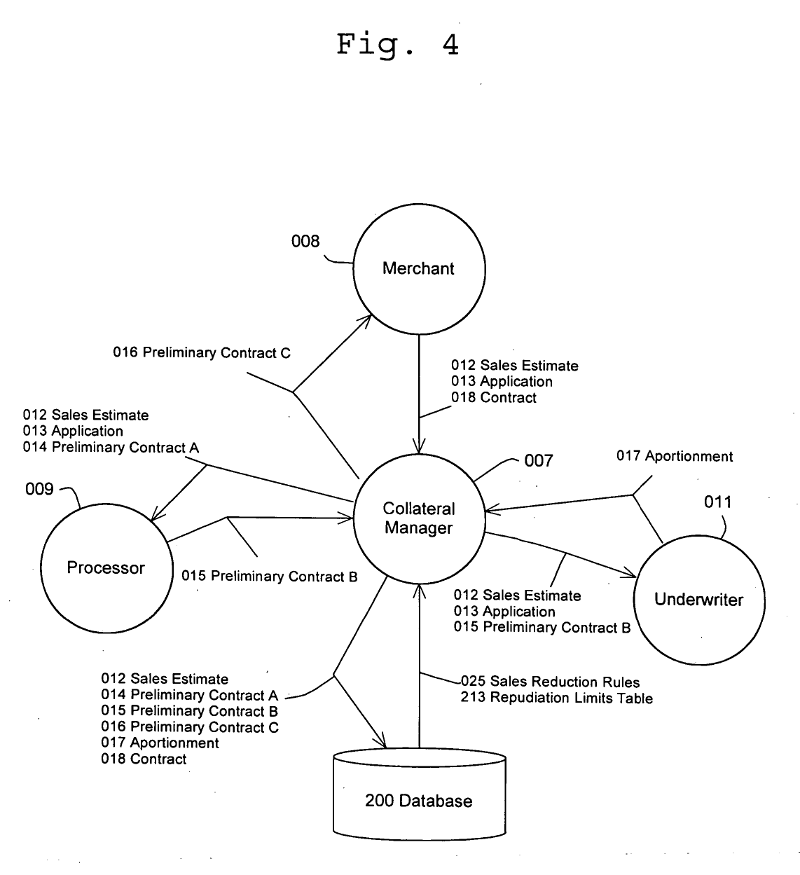

FIG. 5 illustrates the detailed processing of the collateral manger 007 to produce the workflow products shown in FIG. 4.

In this capacity, the collateral manager 007 performs functions necessary to ultimately produce the contract 018, which will contain the information needed to properly administer day-to-day processing of payments and account actions.

The collateral manager 007 receives 501 a transmission of information. The information received may be several information types from any of the system participants. The received information must be identified and acted on properly.

If the information received is an application 013 and sales estimate 012 received from a merchant. The information is stored 503 in the database.

Using the sales estimate 012 and repudiation limits table 213 the maximum collateral is found 504 by determining all permutations of payment methods, payment types and order methods found on the sales estimate 012. The permutations are matched to the repudiation limits table 213 and the permutation with the longest repudiation period is found. The maximum collateral required is then determined by multiplying the longest repudiation period found by the estimated daily sales.

This forms preliminary contract A 014, which is then transmitted 505 to the processor 009.

If the information received 506 is a preliminary contract B 015 from the processor 009 the maximum collateral required might have been adjusted downward by the processor, indicating the processor's willingness to assume some risk. The maximum collateral required is stored 507 on the database, thereby creating preliminary contract B 015, which is transmitted 508 to the underwriters 011.

If the information received 509 is an apportionment 017 from an underwriter 011, the apportionment 017 is stored 510 associated with the information for preliminary contract B 015. When all apportionments are received, preliminary contract B 015 becomes preliminary contract C 016, and is transmitted 511 to the merchant 008.

If the information received 512 is the contract 018 from the merchant 008, the contract is stored 514 on the database and the merchant 008 is enabled 515 for day to day processing is under the terms and conditions of the contract 018.

If the transmission is unrecognized the error is logged and no processing takes place 513.

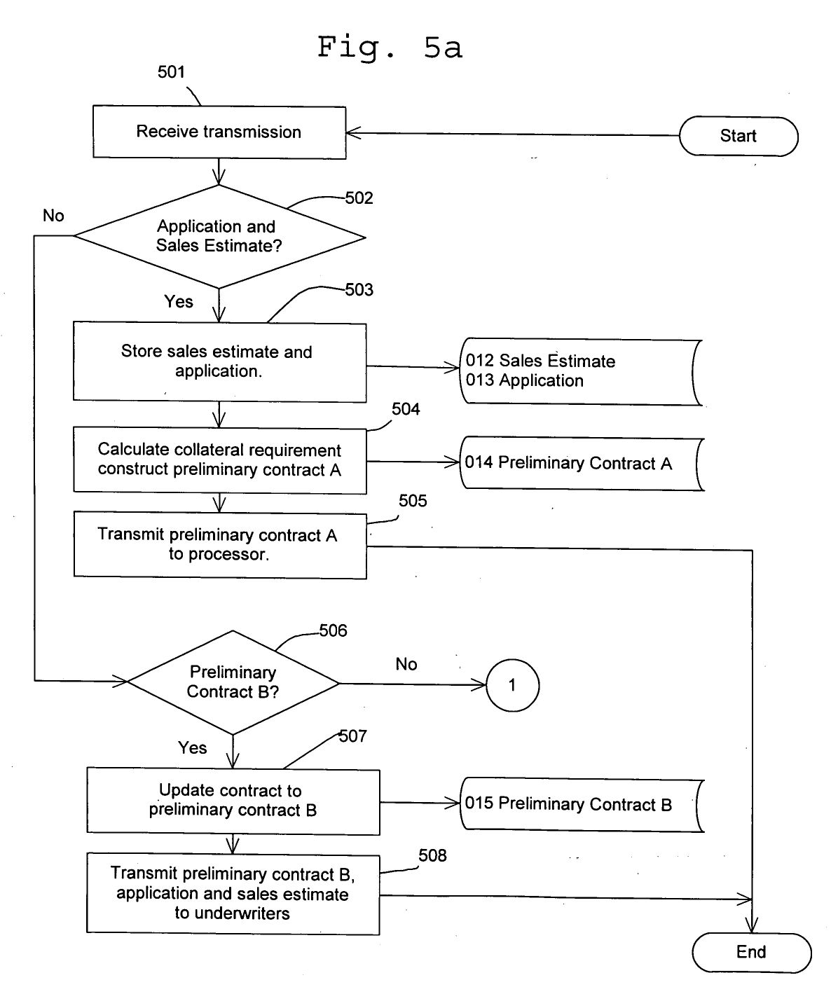

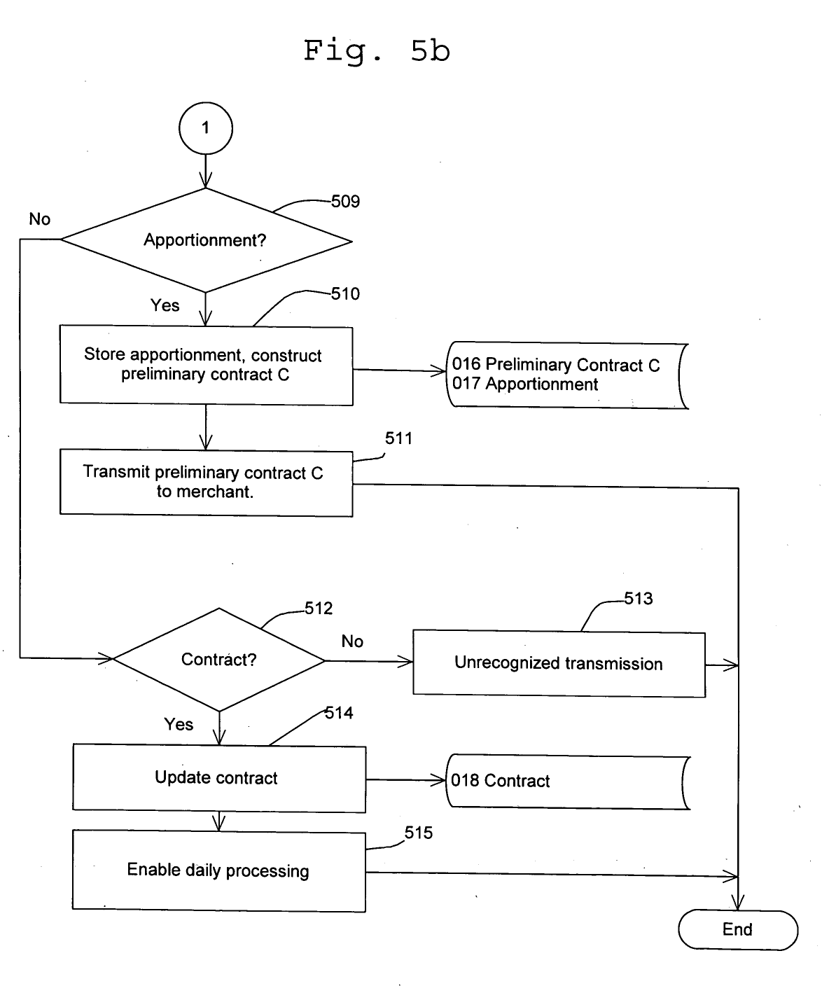

FIG. 6 illustrates the workflow that occurs day-to-day to process payments under the terms and conditions of the contract 018.

Because the maximum amount of collateral that an underwriter has committed to may not be immediately needed and because requiring and restricting from withdrawal the full amount early may cause an under use of funds, the collateral manager 007 will, at any given time, base required collateral on the amount of actual sales and a sales projection over the next several days. As additional collateral becomes needed the underwriter is notified in sufficient time to fund its account.

The merchant 008 submits a payment 019 to the gateway 010. The gateway 010, as is known in the art, is a collection of software and hardware providing one or more means of accepting electronic transactions. Such means may include a graphical user interface allowing a merchant to key enter payments, a batch processing channel allowing a merchant to transmit in a file of predetermined format one or more payments, transmission via a server-to-server connection, or a consumer entered transaction as presented in a shopping cart checkout at the merchant's website. Any functioning payments gateway 010 may be utilized by the invention providing it has the ability to suspend accepting payments for a particular merchant if it should receive an instruction to do so.

The merchant 008 may also initiate an account action 020, such as a withdrawal of funds from its account.

The gateway 010 transmits the payment 019 to both the processor 009 and the collateral manager 007

The processor processes the payment 019. If it knows of an account action 020, such as a withdrawal or deposit, it transmits the account action 020 to the collateral manager 007. If the processor 009 knows of a previously submitted payment that failed to clear it sends a non-payment notice 021 to the collateral manager.

The collateral manager 007 uses any new information it receives, payment 019, account action 020 or non-payment notice 021, to compute the current collateral requirement 022 of the merchant 008 and each participating underwriter 011. Each new collateral requirement 022 is transmitted to the processor 009 so that the required funds may be restricted from withdrawal.

If during computation of the new collateral requirement 022 the collateral manager determines that there is a shortfall in the amount of funds the underwriter 011 has available as collateral it transmits a funding notice 023 to the underwriter 011 requesting that additional collateral funds be provided to make up the shortfall. If the underwriter 011 fails to provide needed funds in a timely manner, and the amount of payments is expected to exceed the required level of collateral, the funds from subsequent payments may be held as collateral in the merchant's account, or a halt payments notice 024 may be transmitted to the gateway 010, instructing it to stop accepting payments for that merchant. In this case the underwriter 011 has breached terms of the contract 018 and remedial action is taken.

The underwriter 011 may receive a funding notice 023, and may initiate an account action 020 on its account held by the processor 009.

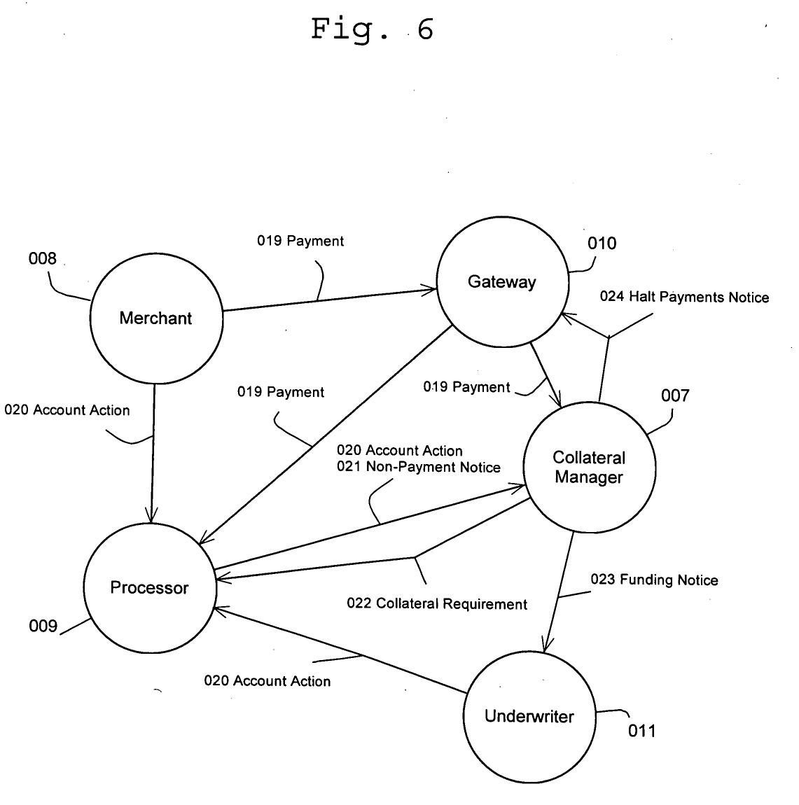

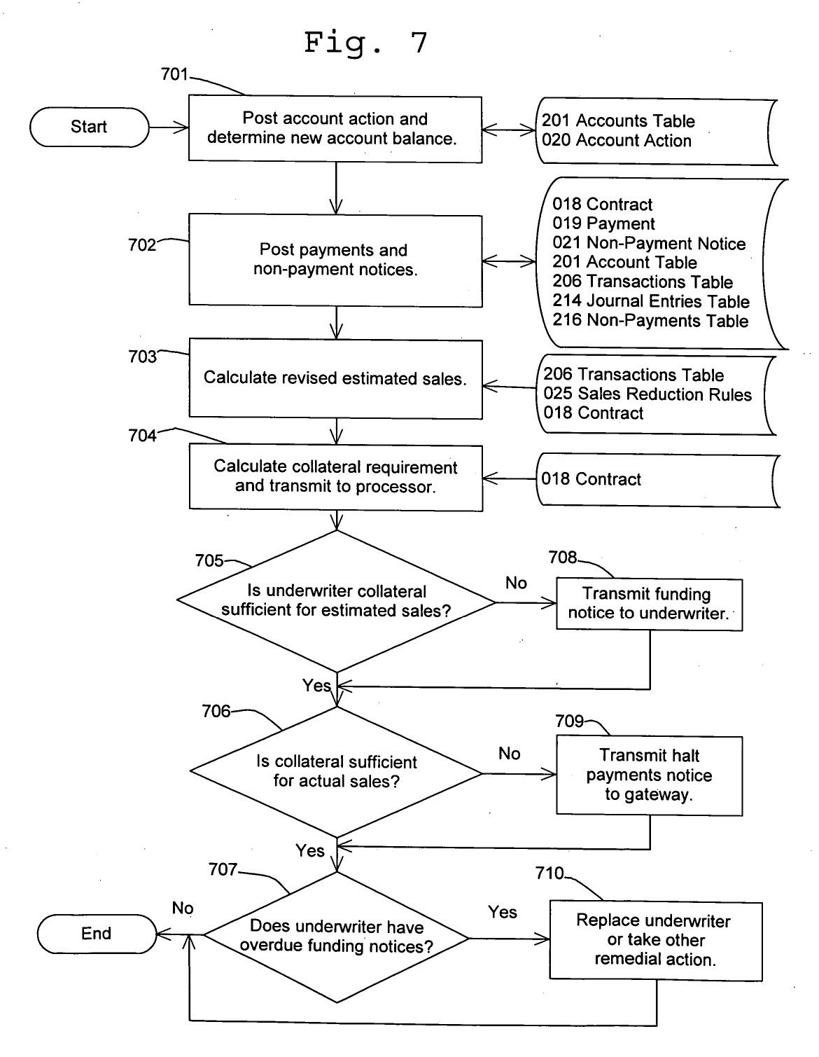

FIG. 7 illustrates the detailed processing of the collateral manger 007 to produce the workflow products shown in FIG. 6.

This process may be executed each time an account action 020, payment 019, or non-payment notice 021 is received to provide a real-time collateral requirement, or periodically as required.

First 701, the account balance on the accounts table is updated with previously unposted account actions received from the processor.

Next 702, any payments received from the gateway 010 or any non-payment notice 021 received from the processor 009 are posted to the transactions table 206 and non-payments table 216. Fees due are calculated journal entries are created and posted to merchant and underwriter accounts on the accounts table 201. At this point the current amount of all funds still on deposit or available to the processor 009 is known.

Next 703, the merchant's payments history, available on the transactions table 206, the original sales estimates which are an element of the contract 018, and the sales reduction rules 025 are used to determine if the sales estimates, and thereby collateral, should be revised downward. Specifically this is done by calculating the current actual to estimated sales ratio and the current elapsed time to contract evaluation period. These ratios are then used to look up the sales reduction factor on the sales reductions table 226, which is applied to the initial collateral amounts to determine the adjusted collateral amounts. This step is done in the event that a merchant's actual sales are significantly less that originally estimated. Without adjustment an unwarranted amount of underwriter's capital may be held as collateral.

Next 704, the collateral requirement that covers all actual sales and a sufficient, but short-term, period of estimated sales is calculated. This is transmitted to the processor 009 so that merchant's and underwriter's accounts may be restricted from over withdrawal, thereby preserving collateral levels.

Next 705, each underwriter's collateral level is compared to a required collateral level for a somewhat longer period of future estimated sales. This will indicate if the underwriter's collateral level is approaching a point where it may not be sufficient in the near future. If collateral is not sufficient for this amount of actual and estimated sales, a funding notice 023 is transmitted to the underwriter 011 requesting that funds or credit line be added to its account 708.

Next 706, each underwriter's collateral level is compared to only actual sales. If collateral is insufficient, and the merchant is unwilling to allow an additional portion subsequent payment amounts to be held as collateral, a halt payments notice 024 is immediately issued to the gateway 010 instructing it not to accept any payment transactions on behalf of the merchant 008.

Next 707, underwriters with collateral shortfalls previously identified in 705, who have previously issued, but delinquent funding notices, are in breach of contract terms. Remedial action must be taken to replace the offending underwriter's collateral before a collateral shortfall described in 706 occurs.

The invention has now been described in detail for the purposes of clarity of understanding. However, it will be appreciated that certain modifications and changes may be practiced within the scope of the appended claims.

1. A method enabling one or more underwriters to insure a processor, which processes non-cash payments on behalf of a merchant, against potential losses as a result of payments that fail to clear or otherwise result in non-payment, and the merchant has insufficient funds or is otherwise unable or unwilling to return funds received from the processor in anticipation of payments successfully clearing, comprising:
a) determining the rates, risk position and insurance limits of each participating underwriter,
b) using merchant and underwriter accounts as collateral to insure availability of funds to cover non-payments,
b) applying relevant transactions including payments, refunds, deposits, withdrawals, fee payments, interest postings, credit line increases and credit line decreases to the merchant and underwriter accounts,
c) comparing payments processed to risk positions and insurance limits to determine the portion of each account committed as collateral,
d) preventing withdrawal or other reduction of the committed portion of the accounts,
e) allowing withdrawal or reduction of the uncommitted portion of the accounts,
whereby the aggregate of the committed portion of all accounts remains sufficient collateral to cover anticipated non-payments.

2. A method according to claim 1, wherein the rates, risk position and insurance limits of each participating underwriter is determined by auction.

3. A method according to claim 1, wherein the rates, risk position and insurance limits of each participating underwriter is determined by setting values for these elements and inviting potential underwriters to accept them.

4. A method according to claim 1, wherein the rates, risk position and insurance limits of each participating underwriter is determined by negotiation between the merchant and each underwriter.

5. A method according to claim 1, wherein the rates, risk position and insurance limits of each participating underwriter may be adjusted depending upon the merchant's payment processing volume.

6. A method according to claim 1, wherein underwriters are notified if their collateral falls below thresholds sufficient to cover anticipated payments.

7. A method according to claim 1, wherein acceptance of payments is stopped if it is anticipated that collateral will be insufficient to cover payments.

8. A computer system controlling the process of establishing and administering collateral accounts for the purpose of insuring a processor of non-cash payments on behalf of a merchant, against potential losses as a result of payments that fail to clear or otherwise result in non-payment, comprising:
a) a server computer that is attached to a network and is able to transmit and receive data from merchants, underwriters, processors and payment collection gateways.
b) a database associated with the server computer, the database containing all information regarding accounts, transactions and agreed upon parameters,
wherein the server computer is configured to recalculate required collateral levels at each transaction event and make notifications to merchants, underwriters, processors and payment collection gateways.

9. A system as in claim 8, wherein the server computer tracks the rates, risk positions, collateral levels and insurance limits of each participating underwriter.

10. A system as in claim 8, wherein the server computer applies relevant transactions including payments, refunds, deposits, withdrawals, fee payments, interest postings, credit line increases and credit line decreases to accounts.

11. A system as in claim 8, wherein the server computer compares payments processed to risk positions and insurance limits to determine the portion of each of the accounts committed as collateral,

12. A system as in claim 8, wherein the server computer makes notifications to prevent reduction of collateral below required levels.

13. A system as in claim 8, wherein the server computer makes notifications to underwriters informing them of the need to increase collateral.

14. A system as in claim 8, wherein the server computer makes notifications to payment collection gateways to stop accepting payments on behalf of the merchant if it is anticipated that collateral will be insufficient.
